(19) United States
(12) Patent Application Publication
(10) Pub. No.: US 2015/0234170 A1
(43) Pub. Date: Aug. 20, 2015

(54) Microscopic Imaging Apparatus and Method to Detect a Microscopic Image

(71) Applicant: STICHTING VU-VUMC, Amsterdam (NL)

(72) Inventors: Stefan Michiel Witte, Amsterdam (NL); Kjeld Sijbrand Eduard Eikema, Amsterdam (NL)

(21) Appl. No.: 14/424,700

(22) PCT Filed: Aug. 27, 2013
(86) PCT No.: PCT/NL2013/050618

§ 371 Date: Feb. 27, 2015

Related U.S. Application Data
(60) Provisional application No. 61/693,465, filed on Aug. 27, 2012.

(30) Foreign Application Priority Data
Aug. 27, 2012 (NL) 2009367

(51) Int. Cl. G02B 21/36; G02B 21/16; G02B 21/06

(52) U.S. Cl. CPC G02B 21/367; G02B 21/06; G02B 21/16

(57) ABSTRACT

A microscopic imaging apparatus to provide an image of a sample. The apparatus includes an illumination system to provide an illumination beam with radiation; and a sensor constructed and arranged to receive: a first image of a first diffraction pattern created by diffraction of the illumination beam on the sample; and a second image of a second diffraction pattern created by diffraction of the illumination beam on the sample.

### FIELD OF THE INVENTION

A microscopic imaging apparatus to provide an image of a sample, the apparatus comprising:
an illumination system to provide an illumination beam with radiation;
a sensor constructed and arranged to receive:
a first image of a first diffraction pattern created by diffraction of the illumination beam on the sample; and,
a second image of a second diffraction pattern created by diffraction of the illumination beam on the sample,
the sensor being operational connectable with a processor running a program to retrieve phase information from the sample from the first and second image received by the sensor.

### BACKGROUND OF THE INVENTION

Microscopic apparatus which retrieve phase information from a sample are gaining popularity in areas where imaging optics are problematic because they may be constructed without lenses, as well as for compact cost-effective reasons. To create different first and second images the position of the sample with respect to the illumination system and/or the sensor may be varied. See for example, Allen, L. J. & Oxley, M. P. Phase retrieval from series of images obtained by defocus lensless imaging. The transverse position of the sample with respect to the illumination system and/or the sensor should be stable at the level of the desired resolution. The required stability and control of the longitudinal position is determined by the Rayleigh length of a spot with a size of the desired resolution R. At a wavelength λ, the allowed deviation Δz can be expressed with equation (1):

$$Δ z \leq \frac{π {R}^{2}}{2 λ} \qquad ( 1 )$$

Using a wavelength λ=500 nm and R=1.0 μm, the position control accuracy may be Δz≦3.1 μm.

To retrieve phase information the apparatus may require a good position control system for the position of the sample with respect to the illumination system and/or the sensor.

Yijin Liu et al., “Phase retrieval using polychromatic illumination for transmission X-ray microscopy”, Opt Express; 2011, Jan. 17; 19(2): 540-545 discloses a transmission X-ray microscope system at sub-50-nm resolution. In order to analyse the phase effect, X-rays of different energy are used in the transmission X-ray microscope. Liu et al use a complex double crystal monochromator for energy tuning, and a Fresnel zone plate as an image-forming element.

### SUMMARY OF INVENTION

It is an objective of the invention to provide an improved microscopic imaging apparatus.

Accordingly there is provided a microscopic imaging apparatus to provide an image of a sample, the apparatus comprising:
an illumination system to provide an illumination beam with radiation;
a sensor constructed and arranged to receive:
a first image of a first diffraction pattern created by diffraction of the illumination beam on the sample;
a second image of a second diffraction pattern created by diffraction of the illumination beam on the sample, the sensor being operational connectable with a
processor provided with a program to retrieve phase information from the sample from the first and second image received by the sensor, wherein the apparatus is
constructed to create on the sensor:
the first image with radiation of substantially a first wavelength of the first diffraction pattern created by diffraction of the first wavelength of the illumination beam on the sample; and,
the second image with radiation of substantially a second wavelength, different than the first wavelength, of the second diffraction pattern created by diffraction of the second wavelength of the illumination beam with the sample, the microscopic imaging apparatus is a lensless microscopic imaging apparatus constructed to create an out of focus image of the sample on the sensor.

With lensless is meant that no lenses, e.g. refractive, diffractive, or other image-forming elements need to be present between the sample and the sensor to form an image. The first and second diffraction pattern are directly imaged on the sensor. The design of the apparatus may thereby be simplified. By creating the first and second images using a different radiation wavelength different first and second images are created.

According to an embodiment the illumination system comprises:
a first illumination device to provide the illumination beam with radiation of substantially the first wavelength; and
a second illumination device to provide the illumination beam with radiation of substantially the second wavelength different than the first wavelength, and the sensor is constructed and arranged to receive:
the first image of the first diffraction pattern created by diffraction of the illumination beam with radiation of substantially the first wavelength on the sample; and,
the second image of the second diffraction pattern created by diffraction of the illumination beam with radiation of substantially the second wavelength on the sample.

By creating the first and second images using a different radiation wavelength in the illumination beam the first and second images are more easily created.

According to an embodiment the illumination system may provide a substantially coherent illumination beam to create the diffraction patterns.

According to an embodiment the apparatus may be provided with a timing controller to control the timing of the illumination beam with radiation of substantially a first wavelength in time with respect to the illumination beam with radiation of substantially a second wavelength. The timing controller may help to create two separate images shortly after each other with the same sensor without the need for filtering of the first and second wavelength.

According to an embodiment the processor may be programmed to retrieve phase information from the sample from the first image of substantially the first wavelength and the second image of substantially the second wavelength received by the sensor. By creating the first and second images using different radiation wavelengths, different first and second images are easily detected.

According to an embodiment the processor may be programmed with a program comprising a phase retrieval algorithm to retrieve phase information from the sample from the first and second image detected by the sensor. The processor may reconstruct a high resolution image of the sample from the phase information.

The apparatus may be a lensless microscope constructed to receive an out of focus image of the sample on the sensor. The out of focus images may be used to reconstruct a high resolution image of the sample from the phase information. Using no optical focussing elements may be applicable when optical focusing elements may be difficult to produce, for example when using X-ray or extreme ultra violet radiation.

According to an embodiment at least one of the first and second illumination devices may comprise a light emitting diode or a laser source to provide radiation for the illumination beam. The first and second illumination device may provide a substantially monochromatic illumination beam.

According to an embodiment the illumination system may comprise combination optics to combine the beam of radiation with substantially a first wavelength with the beam of radiation with substantially a second wavelength into the illumination beam.

According to an embodiment the Illumination system may illuminate the sample with an X-ray beam or extreme ultraviolet radiation. The illumination system may therefore comprise a third generation synchrotron or a high-harmonic generation (HHG) source to provide X-ray radiation or extreme ultra violet radiation. The small wavelength of the X-ray radiation ensures a high spatial resolution for the imaging.

According to an embodiment the apparatus comprises a sample holder and the illumination system, the sample holder, and the sensor are constructed and arranged to detect the image of the sample in reflection on the sensor.

According to an embodiment the apparatus comprises a sample holder and the illumination system, the sample holder, and the sensor are constructed and arranged to detect the image of the sample in transmission on the sensor.

According to an embodiment the microscopic imaging apparatus is constructed and arranged to create a third image of a third diffraction pattern with radiation of substantially a third wavelength, different than the first and second wavelength, created by diffraction of the third wavelength of the illumination beam with the sample and the processor is provided with a program to retrieve phase information from the sample from the first, second and third image received by the sensor.

According to an embodiment the illumination system comprises a third illumination device to provide the illumination beam with radiation of substantially the third wavelength different than the first and second wavelength, and the sensor is constructed and arranged to receive: the third image of the third diffraction pattern created by diffraction of the illumination beam with radiation of substantially the third wavelength on the sample.

According to an embodiment the apparatus is provided with first, second, or third wavelength selectors for creating images with the first, second, or third wavelength.

According to an embodiment the first, second, or third wavelength selectors are provided in the illumination system to provide the illumination beam with radiation of the first, second, or third wavelength.

According to an embodiment the apparatus is constructed to position the first,
second, or third wavelength selectors in front of the sensor to create images of the first, second or third wavelength.

According to an embodiment the wavelength selector is based on a colour filter, grating or a prism.

According to a further embodiment there is provided a method for imaging a microscopic image of a sample with a lensless microscope apparatus constructed to create an out of focus image of the sample on a sensor, the method comprising:
illuminating the sample with an illumination beam with radiation;
detecting with the sensor a first image of a diffraction pattern with radiation of substantially the first wavelength created by illuminating the sample with the illumination beam;
detecting with the sensor a second image of a diffraction pattern with radiation of substantially a second wavelength different than the first wavelength created by illuminating the sample with the illumination beam; and,
running a program to retrieve phase information from the sample from the first and second image received by the sensor.

According to an embodiment there is provided a method comprising:
providing the illumination beam with radiation of the first wavelength and detecting with the sensor a first image of a diffraction pattern with radiation of substantially the first wavelength; and,
providing the illumination beam with radiation of the second wavelength and detecting with the sensor the second image of a diffraction pattern with radiation of substantially the second wavelength.

According to an embodiment there is between illuminating the sample with an illumination beam with radiation of substantially the first wavelength; and, illuminating the sample with radiation of substantially the second wavelength a short time period.

### BRIEF DESCRIPTION OF THE DRAWINGS

Embodiments of the invention will be described, by way of example only, with reference to the accompanying schematic drawings in which corresponding reference symbols indicate corresponding parts, and in which:

FIG. 1 shows a schematic representation of an microscopic imaging apparatus according to an embodiment;

FIG. 2a shows an out of focus image of the sample in a first color;

FIG. 2b shows an out of focus image of the sample in a second color; and,

FIG. 2c shows an in focus image of the sample made by retrieving phase information from the sample from the first and second image of FIGS. 2a and 2b respectively.

### DETAILED DESCRIPTION

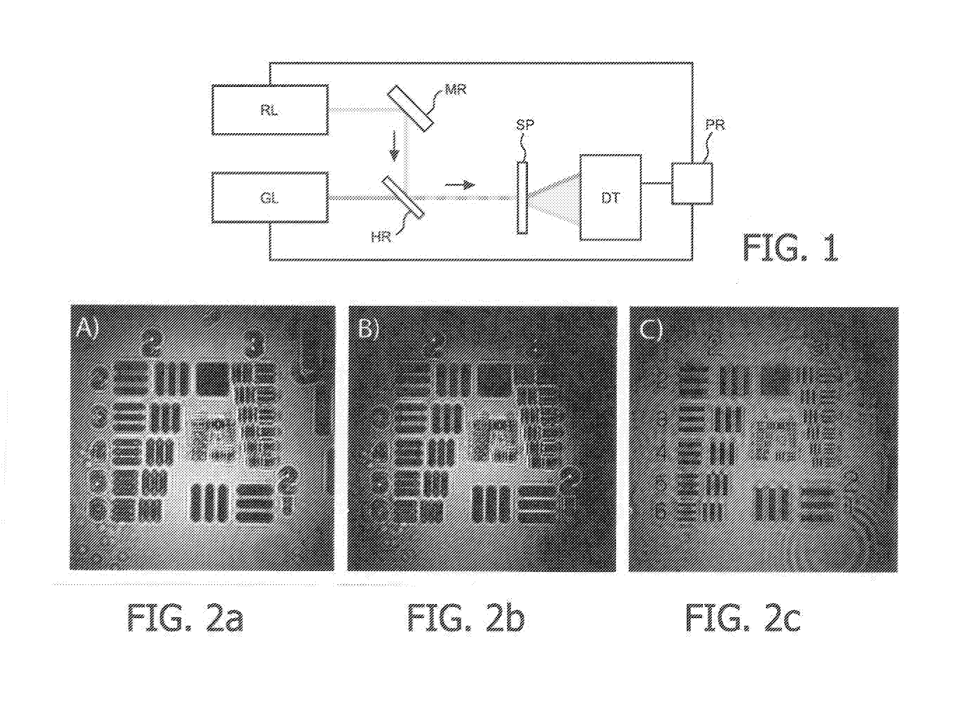

FIG. 1 shows a microscopic imaging apparatus according to an embodiment. The microscopic imaging apparatus is provided with an illumination system to provide an illumination beam of radiation. The apparatus has a sensor DT constructed and arranged to receive:
a first image of a first diffraction pattern created by diffraction of the illumination beam on the sample SP;
a second image of a second diffraction pattern created by diffraction of the illumination beam on the sample SP. The sensor DT, for example a CCD camera being operational connected with a processor PR provided with a program to retrieve phase information from the sample from the first and second image received by the sensor DT.

The apparatus creates on the sensor DT the first image of the first diffraction pattern created by diffraction of the first wavelength of the illumination beam on the sample SP. Further, the second image of the second diffraction pattern may be created by diffraction of the second wavelength, different than the first wavelength, of the illumination beam on the sample SP.

By creating the first and second images using a different radiation wavelength different first and second images may be more easily created. The apparatus may be lensless, such that no lens may be required between the sample and the sensor to receive the first and second diffraction pattern out of focus on the sensor. The design of the apparatus may thereby be simplified. The first and second images may be obtained at any arbitrary distance from the sample without focussing the image. No scanning or otherwise moving components may be needed in the apparatus to retrieve high-resolution phase information.

The illumination system may comprise:
a first illumination device RL to provide the illumination beam with radiation of substantially a first wavelength; and
a second illumination device GL to provide the illumination beam with radiation of substantially a second wavelength. The first wavelength is different than the second wavelength.

The first and second illumination devices may provide a substantially coherent e.g. spatial coherent illumination beam. The coherence is important to retrieve phase information from the sample from the first and second image received by the sensor.

For example, the spatial coherence at the sample SP should be sufficiently high to maintain spatial interference at the sensor DT between the light scattered off two points at the sample SP that are separated by a distance Lc. The spatial coherence length Lc may be determined by the desired resolution R, the distance d between the sample and the sensor, and the wavelength λ by equation 2:

$$Lc \geq 2 d tan ( {sin}^{- 1} ( \frac{λ}{2 R} ) ) \qquad ( 2 )$$

The required spatial coherence may be provided by a laser source, or by an incoherent source such as a LED or a lamp (with the spectral bandwidth requirements as indicated before) which has been spatially filtered by passing the light through a pinhole of finite size before illuminating the sample. The diameter a of such a pinhole can be calculated under the assumption that the far-field condition holds (i.e. a²/(bλ)<<1, where b is the distance between the pinhole and the object).

In this case, the pinhole diameter should be (equation 3):

$$a < 1.22 \frac{b λ}{Lc} \qquad ( 3 )$$

Note that for certain samples, the spatial coherence may be lower than the Lc calculated here.

With substantially a first and second wavelength is meant that the illumination beam radiation may have a small bandwidth. The maximum allowed relative bandwidth Δλ/λ of the illumination beam with central wavelength λ may be determined by the desired image resolution R, the distance d between the sample and the sensor and the size of the camera pixels p of the sensor, according to the equation (4):

$$\frac{Δλ}{λ} < \frac{2 Rp}{d λ} {cos}^{2} ( {sin}^{- 1} ( \frac{λ}{2 R} ) ) \sqrt{1 - {( \frac{λ}{2 R} )}^{2}} \qquad ( 4 )$$

For example, by using a central wavelength λ=500 nm, and camera pixel size of p=4.0 μm, a distance d between the sample and the sensor of d=3.0 mm, and a resolution R=1.0 μm. This results in a relative bandwidth requirement of Δλ/λ≦0.005, and an absolute bandwidth requirement of Δλ≦2.6 nm. For this example the illumination system may therefore provide a substantially monochromatic beam of radiation with a relative wavelength bandwidth of preferably Δλ/λ≦0.005.

The illumination system may provide a beam of radiation with extreme ultraviolet radiation, also called soft X-rays, e.g. radiation with a wavelength between 20 and 0.01 nm, preferably between 10 and 0.1 nm.

Advantageous the illumination system may be providing an illumination beam in the so called water window of X-ray e.g. between 2.34 and 4.4 nm. X-rays in the water window penetrate water while being absorbed by nitrogen. Imaging of biological samples becomes therefore feasible without drying them.

The first and/or second illumination devices may be provided with a laser, or a light emitting diode (LED) to provide radiation. A third generation synchrotron or a high harmonic generation (HHG) source may be used to provide X-ray radiation.

The illumination system may be provided with a mirror MR to redirect the illumination with radiation of substantially the first wavelength.

The illumination system may be provided with a beam combination device e.g. halfway mirror MR, to couple the illumination beam with radiation of substantially the first wavelength into the illumination beam. The beam combination device e.g. halfway mirror HR, may allow the illumination beam with radiation of substantially the second wavelength to traverse into the illumination beam.

The apparatus may be provided with a timing controller, for example in processor PR to control the timing of the illumination beam with radiation of substantially a first wavelength in time with respect to the illumination beam with radiation of substantially a second wavelength. The timing controller may help to create two separate images shortly behind each other with the same sensor without the need for filtering of the first and second wavelength. The processor PR may therefore be connected to the first illumination device and the second illumination device RL, GL.

The illumination beam may illuminate the sample SP, as depicted in FIG. 1 in transmission if the sample is transmissive to the radiation. After transmission and diffraction by the sample the radiation may create a diffraction pattern on the sensor DT.

The illumination beam may illuminate the sample SP in reflection if the sample is reflective to the radiation used. After reflection and diffraction on the sample the radiation may create a diffraction pattern on the sensor.

The sensor is connected with a processor running a program to retrieve phase information from the sample from the first and second image received on the sensor,

The processor may be programmed with a program comprising an iterative phase algorithm to retrieve phase information from the sample from the first and second image detected by the sensor. The processor may reconstruct a high resolution image of the sample from the phase information. The iterative phase retrieval scheme uses the recorded multi-wavelength data to reconstruct the phase without the need for position constraints with respect to the sample.

In the Fresnel regime (near field), wave propagation couples amplitude and phase of an electric field E (X, Y, Z) through the Fresnel diffraction integral:

$$E ( x , y , z ) = \frac{{e}^{i kz}}{i λ z} \int \int E ( {x}^{′} , {y}^{′} , 0 ) {e}^{\frac{iπ}{λ z} [ {( x - {x}^{′} )}^{2} + {( y - {y}^{′} )}^{2} ]} d {x}^{′} d {y}^{′} \qquad ( 5 )$$

where propagation is along the Z-coordinate, and A is the wavelength of the light. From Eq. 5 it is seen that Fresnel propagation (aside from a global phase factor) depends on distance and wavelength in an identical way, allowing to e use our spectrally resolved diffraction data to ‘propagate’ between different spectral components. This novel scheme does not require sample position constraints or sensor or illumination system movement, and only relies on measured data rather than specific sample assumptions or sample position constraints. It converges reliably and works for extended samples, for which traditional sample position constraints-based algorithms fail.

A demonstration of robust multi-wavelength phase retrieval is highlighted in FIG. 2. We record two images in reflection of Fresnel diffraction patterns of a fixed sample (a USAF 1951 test target) at a first (FIG. 2a) red wavelength and a second green wavelength (FIG. 2b). In our multi-wavelength phase retrieval approach, we calculate the amplitude of a single image and propagate this to another wavelength. At this new wavelength the phase is retained, while the amplitude is replaced by the measured amplitude at this particular wavelength. This approach is similar to the Gerchberg-Saxton algorithms, but exploits only measured data rather than prior sample knowledge or sample position constraints.

The multi-wavelength phase retrieval algorithm results in a high-quality image reconstruction, which is displayed in FIG. 2c. Note that the sample fills most of a field-of-view of the microscopic apparatus, so that we have a large field which is imaged. The images made by varying the position of the sample with respect to the illumination beam and or the sensor may have such a stringent position constraints that it is difficult to obtain a full field image. However, our multiwavelength algorithm enables image reconstruction at instrument-limited resolution.

Lensless imaging with visible light sources may be utilized for the development of very compact and cost-effective microscopes.

By combining two-wavelength imaging and multi-wavelength phase retrieval with developments in resolution improvements through sub-pixel interpolation algorithms, a high-resolution lensless optical microscope may be envisaged. The small footprint and low cost of such a system makes it a highly desirable innovation for life science research.

The apparatus may create a third image of a third diffraction pattern with radiation of substantially a third wavelength, different than the first and second wavelength, created by diffraction of the third wavelength of the illumination beam with the sample SP. The processor PR may be provided with a program to retrieve phase information from the sample SP from the first, second and third image received by the sensor DT. The illumination system may comprise a third illumination device to provide the illumination beam with radiation of substantially the third wavelength different than the first and second wavelength. The sensor DT may receive: the third image of the third diffraction pattern created by diffraction of the illumination beam with radiation of substantially the third wavelength on the sample SP.

The microscopic imaging apparatus may be provided with first, second, or third wavelength selectors for creating images of substantially the first, second, or third wavelength. The wavelength selectors may be provided in the illumination system to provide the illumination beam with radiation of the first, second, or third wavelength, for example if the illumination system comprises broadband illumination.

The first, second, or third wavelength selectors may be positioned in front of the sensor DT to create images with the first, second or third wavelength. The wavelength selector may be a colour filter or a prism.

The apparatus may be provided without optical focussing elements (i.e. is lensless) to receive an out of focus image of the sample on the sensor. The out of focus images may be used to reconstruct a high resolution image of the sample from the phase information.

During use of the microscopic imaging apparatus, the apparatus may be:
detecting with a sensor a first image of a diffraction pattern of substantially a first wavelength created by illuminating the sample with radiation;
and,
detecting with a sensor a second image of a diffraction pattern with radiation of substantially the second wavelength created by illuminating the sample with radiation. The first and second images may be created by illuminating the sample with an illumination beam with radiation of substantially the first wavelength and subsequently with an illumination beam with radiation of substantially the second wavelength.

Between illuminating the sample with an illumination beam with radiation of substantially a first wavelength; and, illuminating the sample with radiation of substantially a second wavelength there may be a short time period. The apparatus may therefore be provides with a timing controller, for example in processor PR. The timing controller may help to create two separate images shortly behind each other with the same sensor without the need for filtering of the first and second wavelength.

There may be other ways to create the two or even three separate images for example the sensor may be provided with first, second, or even third wavelength selectors in front of the sensor DT to create images with the first, second or even third wavelength. The wavelength selector may be a colour filter or a prism to filter the first, second or even third wavelength out of the radiation before the sensor is reached. However creating the first, second or even third image by having a time difference between the illumination beam having radiation of the first, second or even third wavelength may be a rather simple solution.

While specific embodiments of the invention have been described above, it may be appreciated that the invention may be practiced otherwise than as described. For example, a fourth or fifth wavelength may be used.

The invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it may be apparent to one skilled in the art that modifications may be made to the invention as described without departing from the scope of the claims set out below.

1. A microscopic imaging apparatus to provide an image of a sample, the apparatus comprising:
an illumination system to provide an illumination beam with radiation;
a sensor constructed and arranged to receive:
a first image of a first diffraction pattern created by diffraction of the illumination beam on the sample;
a second image of a second diffraction pattern created by diffraction of the illumination beam on the sample, the sensor being operational connectable with a processor provided with a program to retrieve phase information from the sample from the first and second image received by the sensor, wherein the apparatus is constructed to create on the sensor:
the first image with radiation of substantially a first wavelength of the first diffraction pattern created by diffraction of the first wavelength of the illumination beam on the sample; and,
the second image with radiation of substantially a second wavelength, different than the first wavelength, of the second diffraction pattern created by diffraction of the second wavelength of the illumination beam with the sample, the microscopic imaging apparatus is a lensless microscopic imaging apparatus constructed to create an out of focus image of the sample on the sensor,
wherein the illumination system comprises:
a first illumination device to provide the illumination beam with radiation of substantially the first wavelength; and
a second illumination device to provide the illumination beam with radiation of substantially the second wavelength different than the first wavelength, and the sensor is constructed and arranged to receive:
the first image of the first diffraction pattern created by diffraction of the illumination beam with radiation of substantially the first wavelength on the sample; and,
the second image of the second diffraction pattern created by diffraction of the illumination beam with radiation of substantially the second wavelength on the sample.

2. (canceled)

3. The microscopic apparatus according to claim 1, wherein the illumination system provides a substantially coherent illumination beam.

4. The microscopic imaging apparatus according to claim 1,
wherein the apparatus is provided with a timing controller to control the timing of the illumination beam with radiation of substantially the first wavelength in time with respect to the illumination beam with radiation of substantially the second wavelength.

5. The microscopic imaging apparatus according to claim 1, wherein the processor is programmed to retrieve phase information from the sample from the first image of substantially the first wavelength and the second image of substantially the second wavelength received by the sensor.

6. The microscopic imaging apparatus according to claim 1, wherein the processor is programmed with a program comprising a phase retrieval algorithm to retrieve phase information from the sample from the first and second image received on the sensor.

7. The microscopic imaging apparatus according to claim 1, wherein the processor reconstructs a high resolution image of the sample from the phase information.

8. The microscopic imaging apparatus according to claim 1, wherein at least one of the first and second illumination device comprises a light emitting diode.

9. The microscopic imaging apparatus according to claim 1, wherein at least one of the first and second illumination device comprises a laser source.

10. The microscopic imaging apparatus according to claim 1, wherein the first and second illumination device provide a substantially monochromatic illumination beam.

11. The microscopic imaging apparatus according to claim 1, wherein the illumination system comprises a beam combination device to combine the beam of radiation with substantially the first wavelength with the beam of radiation with substantially the second wavelength into the illumination beam.

12. The microscopic imaging apparatus according to claim 1, wherein the illumination system illuminates the sample with an X-ray or extreme ultraviolet radiation beam.

13. The microscopic imaging apparatus according to claim 1, wherein the illumination system comprises a third generation synchrotron or a high harmonic generation (HHG) source to provide X-ray radiation or extreme ultraviolet radiation.

14. The microscopic imaging apparatus according to claim 1, wherein the apparatus comprises a sample holder and the illumination system, the sample holder, and the sensor are constructed and arranged to receive the diffraction pattern of the sample in reflection on the sensor.

15. The microscopic imaging apparatus according to claim 1, wherein the apparatus comprises a sample holder and the illumination system, the sample holder, and the sensor are constructed and arranged to receive the image of the diffraction pattern of the sample in transmission on the sensor.

16. The microscopic imaging apparatus according to claim 1, wherein the apparatus is constructed and arranged to create a third image of a third diffraction pattern with radiation of substantially a third wavelength, different than the first and second wavelength, created by diffraction of the third wavelength of the illumination beam with the sample and the processor is provided with a program to retrieve phase information from the sample from the first, second and third image received by the sensor.

17. The microscopic imaging apparatus according to claim 16, wherein the illumination system comprises a third illumination device to provide the illumination beam with radiation of substantially the third wavelength different than the first and second wavelength, and the sensor is constructed and arranged to receive: the third image of the third diffraction pattern created by diffraction of the illumination beam with radiation of substantially the third wavelength on the sample.

18. The microscopic imaging apparatus according to claim 1, wherein the apparatus is provided with first, second, or third wavelength selectors for creating images of substantially the first, second, or third wavelength.

19. The microscopic imaging apparatus according to claim 18, wherein the first, second, or third wavelength selectors are provided in the illumination system to provide the illumination beam with radiation of substantially the first, second, or third wavelength.

20. The microscopic imaging apparatus according to claim 18, wherein the apparatus is constructed to position the first, second, or third wavelength selectors in front of the sensor to create images of the first, second or third wavelength.

21. The microscopic imaging apparatus according to claim 1, wherein the wavelength selector comprises a colour filter, grating or a prism.

22. Method for imaging a microscopic image of a sample with a lensless microscope apparatus constructed to create an out of focus image of the sample on a sensor the method comprising:
illuminating the sample with an illumination beam with radiation;
detecting with the sensor a first image of a diffraction pattern with radiation of substantially the first wavelength created by illuminating the sample with the illumination beam;
detecting with the sensor a second image of a diffraction pattern with radiation of substantially a second wavelength different than the first wavelength created by illuminating the sample with the illumination beam; and,
running a program to retrieve phase information from the sample from the first and second image received by the sensor,
wherein the method comprises:
providing the illumination beam with radiation of the first wavelength with a first illumination system and detecting with the sensor a first image of a diffraction pattern with radiation of substantially the first wavelength; and,
providing the illumination beam with radiation of the second wavelength with a second illumination system and detecting with the sensor the second image of a diffraction pattern with radiation of substantially the second wavelength.

23. (canceled)

24. The method according to claim 22, wherein between illuminating the sample with an illumination beam with radiation of substantially the first wavelength and illuminating the sample with radiation of substantially the second wavelength there is a short time period.
